(19) United States
(12) Patent Application Publication
(10) Pub. No.: US 2025/0238937 A1
(43) Pub. Date: Jul. 24, 2025

(54) IMAGE PROCESSING APPARATUS AND IMAGE PROCESSING METHOD

(71) Applicant: CANON KABUSHIKI KAISHA, Tokyo (JP)

(72) Inventor: ATSUSHI NAGAO, Kanagawa (JP)

(21) Appl. No.: 19/021,710

(22) Filed: Jan. 15, 2025

(30) Foreign Application Priority Data
Jan. 22, 2024 (JP) 2024-007544

(51) Int. Cl. G06T 7/215; G06T 7/246; G06T 7/70; H04N 23/67

(52) U.S. Cl. CPC G06T 7/215; G06T 7/248; G06T 7/70; H04N 23/675; G06T 2207/20081; G06T 2207/30232

(57) ABSTRACT

An image processing apparatus acquires, from an input image based on image data capturing a scene in which a plurality of subjects are moving in a substantially same direction, information regarding a positional relationship of the plurality of subjects in the direction, with use of a trained machine-learning model. In a case where it is determined, based on a reliability of the acquired information, to decide the main subject region, the apparatus decides a main subject region from among subject regions respectively corresponding to the plurality of subjects in the image data, based on the acquired information.

### BACKGROUND OF THE INVENTION

### Field of the Invention

The present invention relates to an image processing apparatus and an image processing method, and more particularly to a technique for detecting the positional relationship of a plurality of subjects from a captured image.

### Description of the Related Art

When capturing a scene in which a plurality of subjects are moving in the same direction, such as an athletics event or race, there are cases in which it is desired to track a subject at a specific position (e.g., the front) rather than a specific subject. In view of this, in Japanese Patent Laid-Open No. 2022-22767, the subject at the front is detected from among a plurality of subjects moving in the same direction, based on the movement direction.

### SUMMARY OF THE INVENTION

However, the positional relationship between the photographer and the subjects is not constant, and the angle of view in capturing is not necessarily constant. Therefore, there are cases where it is not easy to identify the movement directions of the subjects. In one aspect, the present invention provides an image processing apparatus and an image processing method capable of detecting a positional relationship of a plurality of subjects in a movement direction from one frame image.

According to an aspect of the present invention, there is provided an image processing apparatus, comprising: one or more processors that execute a program stored in a memory and thereby function as: an acquisition unit configured to acquire, from an input image based on image data capturing a scene in which a plurality of subjects are moving in a substantially same direction, information regarding a positional relationship of the plurality of subjects in the direction, with use of a trained machine-learning model; and a determination unit configured to decide a main subject region from among subject regions respectively corresponding to the plurality of subjects in the image data, based on the information acquired by the acquisition unit, wherein the determination unit determines whether or not to decide the main subject region, based on a reliability of the information, and decides the main subject region if it is determined to decide the main subject.

According to another aspect of the present invention, there is provided an image processing method comprising: acquiring, from an input image based on image data capturing a scene in which a plurality of subjects are moving in a substantially same direction, information regarding a positional relationship of the plurality of subjects in the direction, with use of a trained machine-learning model; and deciding a main subject region from among subject regions respectively corresponding to the plurality of subjects in the image data, based on the information acquired in the acquiring, wherein the deciding includes determining whether or not to decide the main subject region, based on a reliability of the information and deciding the main subject region if it is determined to decide the main subject.

According to a further aspect of the present invention, there is provided a non-transitory computer-readable medium stores a program which causes, when executed by one or more processors of a computer, the computer to perform an image processing method comprising: acquiring, from an input image based on image data capturing a scene in which a plurality of subjects are moving in a substantially same direction, information regarding a positional relationship of the plurality of subjects in the direction, with use of a trained machine-learning model; and deciding a main subject region from among subject regions respectively corresponding to the plurality of subjects in the image data, based on the information acquired in the acquiring, wherein the deciding includes determining whether or not to decide the main subject region, based on a reliability of the information and deciding the main subject region if it is determined to decide the main subject.

Further features of the present invention will become apparent from the following description of exemplary embodiments (with reference to the attached drawings).

### BRIEF DESCRIPTION OF THE DRAWINGS

FIG. 1 is a diagram showing an example of the configuration of a camera as an example of an image processing apparatus according to a first embodiment.

FIG. 2 is a block diagram showing an example of the functional configuration of the camera according to the first embodiment.

FIG. 3 is a flowchart relating to the operation of the camera according to the first embodiment.

FIG. 4 is a flowchart relating to main subject region determination processing in the first embodiment.

FIGS. 5A to 5B are diagrams for describing main subject region decision processing in the first embodiment.

FIGS. 6A to 6C are diagrams for describing main subject region decision processing in the first embodiment.

FIG. 7 is a flowchart relating to main subject region decision processing in a second embodiment.

FIGS. 8A to 8B are diagrams for describing main subject region decision processing in the second embodiment.

FIGS. 9A to 9C are diagrams for describing main subject region decision processing in the second embodiment.

FIG. 10 is a flowchart relating to main subject region decision processing in a third embodiment.

FIGS. 11A to 11B are diagrams for describing main subject region decision processing in the third embodiment.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

In the following embodiments, the present invention will be described with reference to a digital single-lens reflex camera. Although the present invention can be favorably used for controlling an image capturing operation, an image capturing function is not essential in a device or apparatus for implementing the present invention. The present invention can be implemented in any electronic device or apparatus capable of handling image data. Examples of such electronic devices or apparatus include video cameras, computer devices (personal computers, tablet computers, media players, PDAs, etc.), mobile phones, smartphones, game consoles, robots, drones, and drive recorders. These are merely examples, and the present invention can also be implemented in other electronic devices or apparatuses.

### First Embodiment

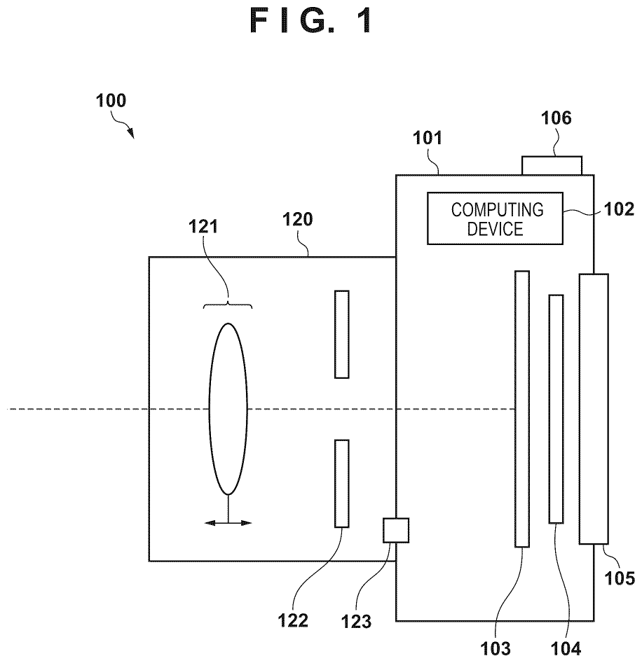

FIG. 1 is a vertical view schematically showing main components of a digital single-lens reflex camera (hereinafter simply referred to as the “camera”) 100 as an example of an image processing apparatus according to a first embodiment of the present invention, and an example of the arrangement of the main components. The camera 100 includes a body 101 and a detachable lens unit 120. The lens unit 120 includes a plurality of lenses (including a focus lens 121), an aperture 122, and a mechanism for driving movable members.

The lens unit 120 and the body 101 are detachably connected by mount portions that engage with each other. The mount portions are provided with contact portions 123 having a plurality of terminals, and power is supplied from the body 101 to the lens unit 120 through the contact portions 123. Furthermore, operation of the focus lens 121 and the aperture 122 can be controlled from the body 101 (computing device 102) via the contact portions 123.

A shutter 103 provided between the lens unit 120 and an image sensor 104 opens and closes under the control of the computing device 102 to control the exposure period of the image sensor 104. Note that if the exposure period of the image sensor 104 is controlled by a so-called electronic shutter, the shutter 103 that physically opens and closes may be omitted.

The image sensor 104 may be, for example, a known CCD or CMOS color image sensor having a primary color Bayer array color filter. The image sensor 104 has a pixel array in which a plurality of pixels are arranged two-dimensionally, and a peripheral circuit for reading out signals from the pixels. Each pixel accumulates electric charge according to the amount of incident light through photoelectric conversion. A signal having a voltage corresponding to the amount of charge accumulated during the exposure period is read out from each pixel, thereby obtaining a group of pixel signals (analog image signal) representing a subject image formed on the imaging surface by the lens unit 120.

A display unit 105 is provided on the surface of the housing of the camera 100, and displays live view video, recorded images, menu screens, and the like. The display unit 105 may be, for example, a liquid crystal display (LCD). Moreover, the display unit 105 may be a touch display.

An operation unit 106 is a general term for input devices (e.g., buttons, switches, and dials) provided on the camera 100 for allowing the user to input various instructions to the camera 100. The input devices constituting the operation unit 106 have names that correspond to the functions assigned thereto. Examples include a release switch, a moving image recording switch, a shooting mode selection dial for selecting a shooting mode, a menu button, direction keys, and an enter key. The release switch is a switch for recording still images, and the computing device 102 recognizes a half-press state of the release switch as an instruction to prepare for image capturing, and a full-press state as an instruction to start image capturing. Also, when the moving image recording switch is pressed in the capturing standby state, the computing device 102 recognizes this as an instruction to start recording a moving image, and when the moving image recording switch is pressed during recording of a moving image, the computing device 102 recognizes this as an instruction to stop recording. Note that various functions may be assigned to the same input device. The input devices may also be software buttons or keys displayed using a touch display. Furthermore, the operation unit 106 may include an input device that supports a non-contact input method, such as voice input or eye-gaze input.

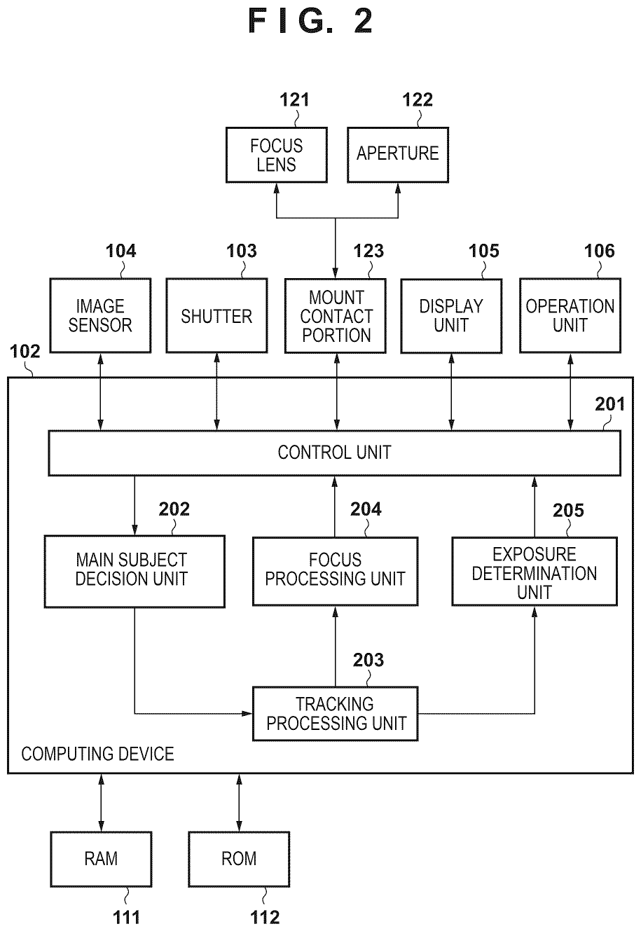

The computing device 102 has one or more processors (hereinafter referred to as CPUs) capable of executing programs, and, for example, a program stored in a ROM 112 (FIG. 2) is loaded to a RAM 111 (FIG. 2) and executed by the one or more CPUs. The computing device 102 realizes functions of the camera 100 by controlling the operations of the components of the camera 100 in accordance with a program. Furthermore, upon detecting an operation performed on the operation unit 106, the computing device 102 executes an operation that corresponds to the detected operation.

FIG. 2 is a block diagram showing an example of the functional configuration of the camera 100. Components the same as those in FIG. 1 are denoted by the same reference numerals as those in FIG. 1.

Functional blocks 201 to 205 of the computing device 102 schematically show main functions realized by execution of a program by one or more CPUs of the computing device 102. Note that a CPU may use a separate hardware circuit to implement one or more of the functional blocks. For example, a graphics processing unit (GPU) or an application specific integrated circuit (ASIC) can be used for processing related to image processing. Also, a neural processing unit (NPU) can be used for processing related to a trained machine-learning model. Such hardware circuits may be included in the computing device 102 or may be external circuits outside of the computing device 102.

Also, the functional blocks 201 to 205 are part of the operations implemented by the computing device 102. Therefore, in the following description, operations may be implemented by the computing device 102 or may be implemented by the functional blocks 201 to 205.

The RAM 111 is used to load a program executed by the CPU of the computing device 102 and to store values required during the execution of the program. Also, portions of the RAM 111 are used as a buffer for temporarily storing captured image data, and as a video memory for the display unit 105.

The ROM 112 is an electrically rewritable non-volatile memory. The ROM 112 stores a program executable by the CPU of the computing device 102, setting values of the camera 100, GUI data, and the like.

Note that in order to simplify the description of the embodiment, FIG. 2 shows only some of the components of the camera 100. In reality, the camera 100 also includes components that a typical camera has, such as a power source, a recording medium, and a communication interface.

A control unit 201 controls operations of the body 101 and the lens unit 120. For example, the control unit 201 controls the operation timing of the image sensor 104 and reads out analog image signals from the image sensor 104. Furthermore, the control unit 201 applies A/D conversion and predetermined image processing to analog image signals to generate signals and image data according to applications, and acquires and/or generates various types of information. For example, the control unit 201 generates image data for display or recording, and generates evaluation values and signals used for automatic focus detection (AF) and automatic exposure control (AE).

The main subject decision unit 202 detects subject regions included in an image, and decides, from among the detected subject regions, a main subject region on which the camera 100 is to focus. Based on one captured frame image, the main subject decision unit 202 decides, from among a plurality of subject regions, the subject region estimated to have the highest probability of being located at a specific position (here, the front) in a movement direction, as a main subject region. Operation of the main subject decision unit 202 will be described in detail later.

A tracking processing unit 203 searches for the main subject region decided by the main subject decision unit 202 in a subsequent frame. There is no limitation on the search method, and any known method can be used, such as pattern matching using the main subject region as a template, or a method using a feature amount extracted from the main subject region. The tracking processing unit 203 outputs position information of the found main subject region, and also generates information to be used in the next search according to the search method. For example, when template matching is used, the tracking processing unit 203 uses the decided main subject region as the template used in the next search for the main subject region.

A focus processing unit 204 calculates a driving amount and a driving direction for the focus lens 121 such that a focus detection region set in the main subject region is brought into focus. The focus processing unit 204 can calculate the driving amount and the driving direction for the focus lens 121 by a known method such as a contrast method or a phase difference detection method.

An exposure determination unit 205 determines exposure parameters (aperture value, shutter speed, and imaging sensitivity) that result in proper exposure of the main subject region. The exposure determination unit 205 can determine exposure parameters based on, for example, an evaluation value generated by the control unit 201 and a program diagram.

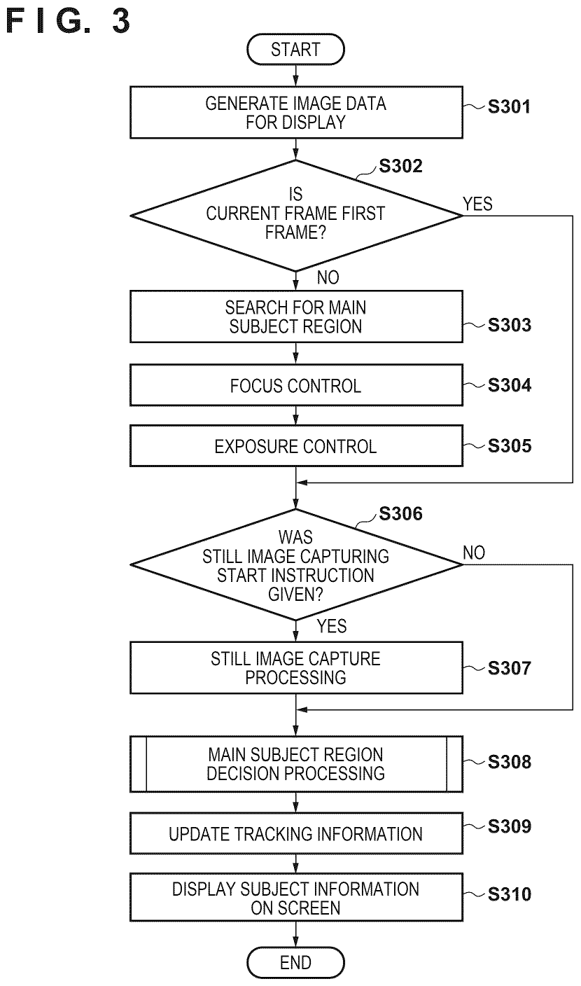

Next, operation of the camera 100 in the present embodiment will be described with reference to the flowchart shown in FIG. 3. This operation is started in the standby state in the still image capturing mode. In the standby state, moving image capturing for performing live view display on the display unit 105 is executed. Note that the following assumes a scene in which a plurality of subjects are moving in substantially the same direction, and therefore the operations described below may be performed when, for example, a mode for shooting such a scene is set.

In step S301, the control unit 201 reads out an image signal corresponding to one frame from the image sensor 104, and generates image data to be displayed on the display unit 105 from the image signal. The control unit 201 stores the generated image data in the RAM 111.

In step S302, the computing device 102 determines whether or not the currently processed frame is the first frame or not, executes step S306 if it is determined that the currently processed frame is the first frame, and executes step S303 if otherwise.

In step S303, the tracking processing unit 203 searches for the position, in the current frame, of the main subject region set in the previous frame, using tracking reference information generated in step S310 in processing executed for the previous frame. The tracking processing unit 203 stores information on (e.g., the position and size of) the main subject region found in the current frame in the RAM 111 as a tracking result.

In step S304, the focus processing unit 204 sets a focus detection region in the main subject region based on the tracking result generated in step S303. The focus processing unit 204 uses the evaluation value and the signal generated by the control unit 201 in step S301 to determine a movement amount and a movement direction for the focus lens 121 in order for the focus detection region to be in focus. The focus processing unit 204 notifies the control unit 201 of the determined movement amount and movement direction. Upon receiving the notification, the control unit 201 executes control to drive the focus lens 121 by the notified movement amount in the notified movement direction.

In step S305, the exposure determination unit 205 uses the evaluation value generated in step S301 to determine exposure parameters such that the main subject region based on the tracking result is properly exposed. The exposure determination unit 205 notifies the control unit 201 of the determined exposure parameters. Upon receiving the notification, the control unit 201 controls the shutter speed, the imaging sensitivity, and the aperture 122 for capturing the next frame in accordance with the exposure parameters.

In step S306, the control unit 201 determines whether or not it was detected that a still image capturing start instruction was given via the operation unit 106. If it is determined that a capturing start instruction was detected, the control unit 201 executes step S307, and if not, executes step S308.

In step S307, the control unit 201 executes still image capturing processing. The control unit 201 drives the shutter 103 based on the exposure parameters notified in step S305 to expose the image sensor 104 to light. Then, still-image image data for recording is generated from the signals read out from the image sensor 104. The control unit 201 records the generated image data on a recording medium (not shown) such as a memory card.

In step S308, the control unit 201 instructs the main subject decision unit 202 to decide the main subject region. In response to the instruction, the main subject decision unit 202 decides the main subject region based on the image data generated in step S301. The main subject decision unit 202 notifies the control unit 201 and the tracking processing unit 203 of information on the decided main subject region. The main subject region decision processing will be described later in detail.

In step S309, the tracking processing unit 203 generates tracking information to be used in tracking processing for the next frame (step S302) based on the information on the main subject region notified in step S308 and the image data generated in step S301. As described above, the tracking information may differ depending on the tracking method.

In step S310, the control unit 201 superimposes an indicator (e.g., a frame) indicating the main subject region on the image data generated in step S301 based on the information on the main subject region notified in step S308, and displays the resulting image on the display unit 105.

The above operations are performed each time a live view image frame is captured. While the camera 100 is operating in the still image capturing mode, the series of processing shown in FIG. 3 is repeatedly executed.

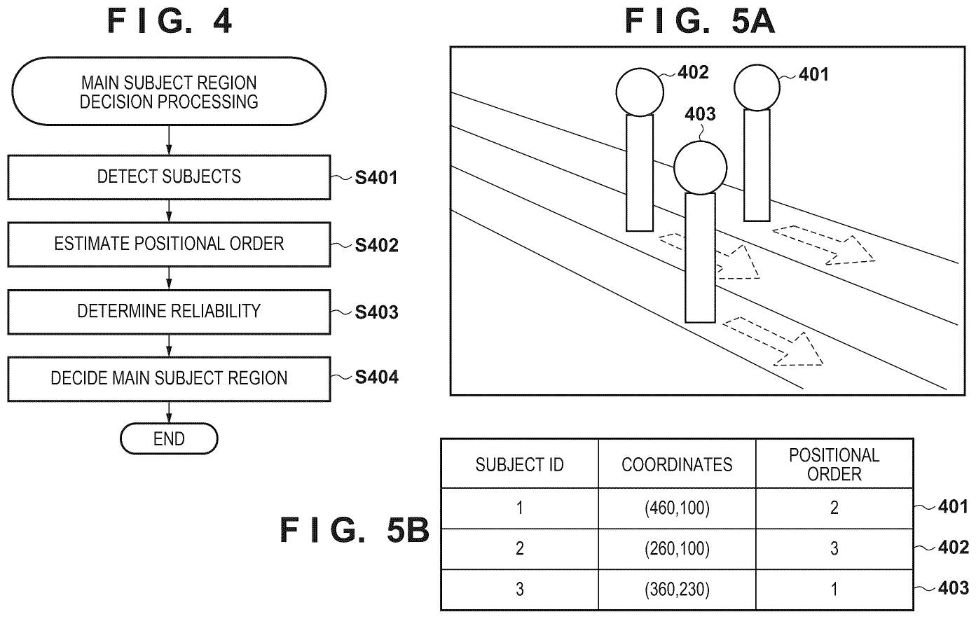

Next, the main subject region decision processing executed by the main subject decision unit 202 in step S308 will be described in further detail with reference to the flowchart shown in FIG. 4.

In step S401, the main subject decision unit 202 executes subject detection processing on the image data generated in step S301. Although human subjects are detected here, other types of subjects such as animals and vehicles may also be detected. Any known method can be used for detection. For example, a trained machine-learning model such as a convolutional neural network (CNN) trained using images of people can be used. Also, a method such as AdaBoost that combines multiple trained machine-learning models may be used.

In step S402, the main subject decision unit 202 (acquisition unit) estimates a positional order in the movement direction for each of the human subjects detected in step S401. The positional order is a discrete value that increases by one such as first, second, third, and so on, beginning at the subject located at the front in the movement direction. The positional order in the movement direction can be acquired by, for example, inference processing using a trained machine-learning model such as a CNN trained using a training dataset made up of a combination of images containing a plurality of subjects and the positional order in the movement direction for each subject region in the images. Note that in the case where the subject region detection results acquired in step S401 are used in inference, information on the subject regions is also used during training. For example, the results of subject region detection can be used in any way in training and inference, such as extracting subject regions from the original image and using them as input images for the CNN.

FIG. 5A is an example of an image expressed by the image data generated in step S301. The image shows a plurality of human subjects 401, 402, and 403 moving in the direction indicated by the arrows (the arrows are not included in the image). FIG. 5B shows an example of the subject detection result in step S401 for the image shown in FIG. 5A and the estimated positional order for each subject region acquired in step S402. Here, the human head is detected as the subject region, and image coordinates corresponding to the center of gravity of the subject region are shown as the coordinates of the subject region. Also, subject IDs 1 to 3 that identify subject regions correspond to the human subjects 401 to 403, respectively.

In step S403, the main subject decision unit 202 (determination unit) determines the reliability of the positional order estimated in step S402. As one example, the main subject decision unit 202 determines the reliability of the positional order estimated for the current frame based on a positional order estimated in the past for the same subject region. Considering the capturing interval (generally 1/30th of a second for video capturing), the amount of change from a previous estimated positional order is expected to be ±1. Therefore, if the positional order changes by ±2 or more, the main subject decision unit 202 determines that the reliability of the positional order inferred by the trained machine-learning model is low.

Specifically, the main subject decision unit 202 determines that the reliability of the positional order is low (reliability=0) if the following condition is satisfied, and determines that the reliability of the positional order is high (reliability=1) if the following condition is not satisfied.
Condition: positional order of any subject changed by threshold value or more from previous estimated positional order

(In the present embodiment, the threshold value is +2, and if the change in positional order is an absolute value, the threshold value is 2.)

If the current frame is the first frame, there is no previous positional order, and therefore the reliability is set to 0.

Note that although the threshold value is set to 2 here, the threshold value may be dynamically determined according to, for example, the number of subjects. For example, in the case where there are a large number of subjects, such as immediately after the start of a marathon or other race, the threshold value can be temporarily set to 3 or more. The threshold value may also be determined taking other conditions into consideration, such as setting the threshold value to a larger value the larger the inverse of the capturing interval or frame rate is or the longer the interval of execution of positional order estimation is. Also, the threshold value may be set taking into consideration not only the most recent positional order but also a plurality of past positional orders.

In step S404, the main subject decision unit 202 (determination unit) decides a main subject region from among the subject regions detected in step S401.

If a decided main subject region does not exist (there is no main subject), and if it was determined in step S403 that the reliability of the positional order is high (reliability=1), the main subject decision unit 202 decides the subject region whose positional order is first in the current frame as the main subject region. On the other hand, if it was determined in step S403 that the reliability of the positional order is low (reliability=0), the main subject decision unit 202 does not decide a main subject region.

If a decided main subject region exists (there is a main subject), the main subject decision unit 202 determines whether or not to switch the main subject region based on the positional order acquired in step S402 and the reliability determined in step S403. Specifically, the main subject decision unit 202 determines to switch the main subject region if both of the following conditions A and B are satisfied, and determines not to switch the main subject if one or more of the conditions is not satisfied.
Condition A: subject region with estimated positional order of first is different from previous frame
Condition B: reliability of estimated positional order in current frame is high (reliability=1)

In the case of determining to switch the main subject region, the main subject decision unit 202 decides the subject region with the estimated positional order of first in the current frame as the new main subject region. On the other hand, in the case of determining not to switch the main subject region, the main subject decision unit 202 maintains the main subject region that has been decided.

The main subject region switching operation in step S404 will be described in more detail below with reference to FIGS. 6A to 6C. FIG. 6A shows an example of the history of the positional order for each subject region at a time t (current frame) and in the three previous frames. The positional order history is stored by the main subject decision unit 202 in the RAM 111, for example, and is successively updated after execution of step S402. Hereinafter, the subject regions with the subject IDs 1 to 3 will be referred to as subject regions 1 to 3, respectively.

In this example, the positional order remains unchanged up to the previous frame (time t−1), but the subject regions with the positional orders of first and second are swapped in the current frame (time t), and therefore the condition A is satisfied. Also, the amount of change in the positional order between the previous frame and the current frame is within the range of +1 for all of the subject regions 1 to 3, and therefore the reliability of the estimated positional order in the current frame is high, and the condition B is satisfied. Therefore, the main subject decision unit 202 switches the main subject region from the subject region 1 to the subject region 2.

FIG. 6B shows another example of the positional order history. In this example, the positional order remains unchanged up to the previous frame (time t−1), but the subject regions with the positional orders of first and third are swapped in the current frame (time t), and therefore the condition A is satisfied. On the other hand, the amount of change in the positional order between the previous frame and the current frame is +2 for the subject regions 1 and 3, which exceeds the threshold value, and therefore the reliability of the estimated positional order in the current frame is low, and the condition B is not satisfied. Therefore, the main subject decision unit 202 does not switch the main subject region, and maintains the subject region 1, which had the positional order of first in the previous frame, as the main subject region.

FIG. 6C shows yet another example of the positional order history. In this example, the positional order remains unchanged up to the previous frame (time t−1), but the positional order has changed in the current frame (time t) for all of the subject regions, and therefore the condition A is satisfied. Also, the amount of change in the positional order between the previous frame and the current frame is +1 for the subject regions 1 and 2, but the amount of change in the positional order is −2 for the subject region 3, which exceeds the threshold value. Therefore, the reliability of the estimated positional order in the current frame is low, and the condition B is not satisfied. Therefore, the main subject decision unit 202 does not switch the main subject region, and maintains the subject region 1, which had the positional order of first in the previous frame, as the main subject region.

According to the present embodiment, processing is performed using a trained machine-learning model that estimates the positional relationship for a plurality of subjects in the movement direction based on the current frame image, and therefore there is no need to calculate motion vectors. Therefore, there is no need to hold previous frame images. Also, it is possible to suppress erroneous detection of the positional relationship when the positional relationship between the photographer and the subject changes or the angle of view changes.

Also, by not switching the main subject region when it is determined that the reliability of the estimation result for the current frame acquired by the trained machine-learning model is low, erroneous switching of the subject region can be further suppressed.

### Second Embodiment

Next, a second embodiment of the present invention will be described. In the first embodiment, the positional relationship (positional order) in the movement direction is estimated for each subject. In the present embodiment, instead of the positional order, a front likelihood proportional to distance in the movement direction is estimated.

The present embodiment differs from the first embodiment in the main subject region determination processing carried out in step S308 in FIG. 3. The configurations and other operations of the image processing apparatus may be similar to those of the first embodiment. Therefore, the following description focuses on the operation of the main subject decision unit 202 in the present embodiment.

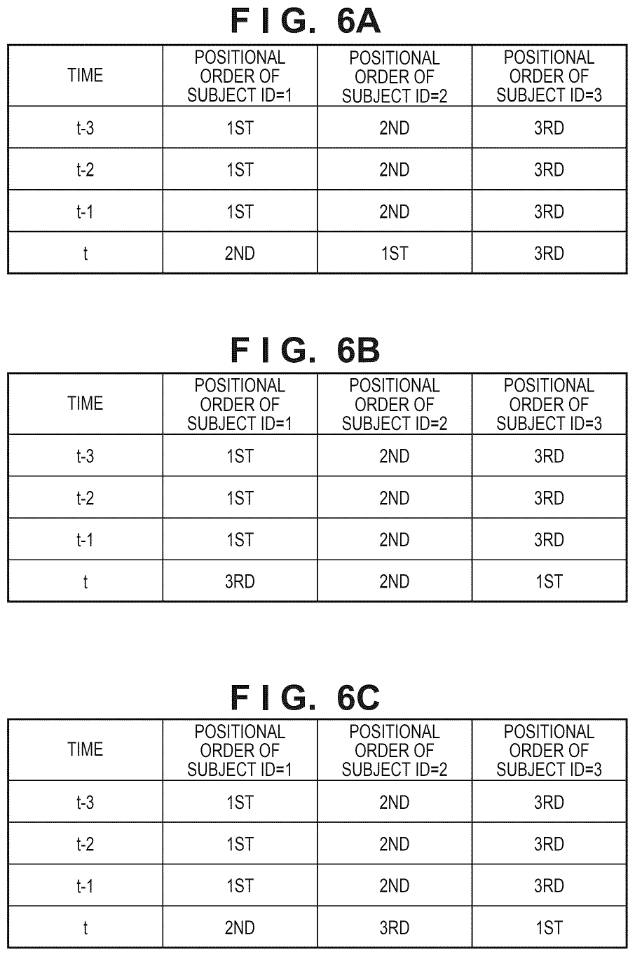

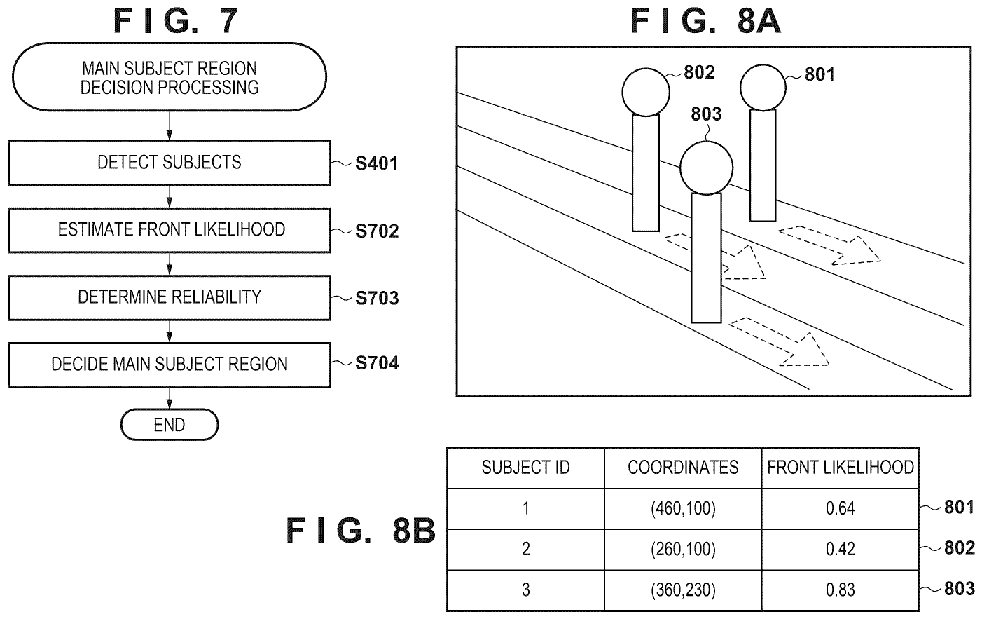

FIG. 7 is a flowchart relating to the main subject decision processing performed by the main subject decision unit 202 in the present embodiment. In FIG. 7, steps for executing the same processing as in the first embodiment are given the same reference numerals as in FIG. 4, and descriptions thereof will be omitted.

In step S702, the main subject decision unit 202 estimates a front likelihood for each of the subject regions detected in step S401. Here, the front likelihood is a real number that can have a value from 0 to 1, with the value increasing the further forward in the movement direction the subject is, and the value decreasing the further rearward the subject is. Furthermore, the difference between the front likelihoods of two subject regions is proportional to the distance between the subjects in the movement direction in real space. In other words, the magnitude of the difference between the front likelihoods of two subject regions represents the magnitude of the distance in the movement direction between the two corresponding subjects in real space.

The front likelihood can be acquired by, for example, inference processing using a trained machine-learning model such as CNN trained using a training dataset made up of a combination of images containing a plurality of subjects and the front likelihood of each subject region in the images. Note that in the case where the subject region detection results acquired in step S401 are used in inference, information on the subject regions is also used during training. For example, the results of subject region detection can be used in any way in training and inference, such as extracting subject regions from the original image and using them as input images for the CNN.

FIG. 8A shows an example of an image similar to that in FIG. 5A, except that the reference numbers of the human subjects are different. FIG. 8B shows an example of the subject detection result in step S401 for the image shown in FIG. 8A and the front likelihood for each subject region acquired in step S702. Here too, the human head is detected as the subject region, and image coordinates corresponding to the center of gravity of the subject region are shown as the coordinates of the subject region. Also, the subject IDs 1 to 3 that identify subject regions correspond to the human subjects 801 to 803, respectively.

In step S703, the main subject decision unit 202 determines the reliability of the front likelihoods estimated in step S702. As an example, for each subject region, the main subject decision unit 202 determines the reliability of the front likelihood estimated for the current frame based on a front likelihood estimated in the past. Considering the capturing interval (generally 1/30 seconds for video capturing), it is unlikely that the relative distance to another subject will change drastically between the frame in which the previous front likelihood was estimated and the current frame. Therefore, for a subject region for which the amount of change in the difference in front likelihood from one or more other subject regions exceeds a threshold value, the main subject decision unit 202 determines that the reliability of the front likelihood inferred by the trained machine-learning model is low. The reason why the difference in front likelihood is used instead of the front likelihood for a subject region is that the value of the front likelihood can change by a large amount in a short period of time due to, for example, panning of the camera.

For the subject region with the subject ID of i (hereinafter referred to as the subject region i) at a time t, let hᵢ(t) be the front likelihood and let ωᵢ(t) be the reliability of the front likelihood. Also, let d_{i,j}(t) be the difference hᵢ(t)−hⱼ(t) in front likelihood between the subject region i and the subject j at the time t. Note that in the example shown in FIGS. 8A to 8B, 1≤i,j≤3.

The main subject decision unit 202 determines whether or not there is a subject region j that satisfies |d_{i,j}(t)−d_{i,j}(t−1)|>θ with respect to the subject region i. In the case of determining that such a subject region j exists, the main subject decision unit 202 determines that the reliability of the front likelihood estimated for the subject region i in the current frame is low (ωᵢ(t)=0). Furthermore, in the case where such an subject region j does not exist, the main subject decision unit 202 determines that the reliability of the front likelihood estimated for the subject region i in the current frame is high (reliability ωᵢ(t)=1). Here, θ is a predetermined threshold value.

In other words, for the subject region i in the current frame, if there is another subject region for which the change in the difference in front likelihood from the previous frame exceeds a threshold value, the main subject decision unit 202 determines that the reliability of the front likelihood estimated in the current frame is low. Note that when the current frame is the first frame, since there is no front likelihood that was estimated in the past, the reliability of the front likelihood is determined to be low for all subject regions i (in other words, ωᵢ(t)=0).

In step S704, the main subject decision unit 202 decides the main subject region from among the subject regions detected in step S401.

In the case where a decided main subject region does not exist (there is no main subject), if the reliability determined in step S703 for the subject region with the highest front likelihood in the current frame is high, the main subject decision unit 202 decides the subject region with the highest front likelihood as the main subject region. On the other hand, if the reliability determined in step S703 for the subject region with the highest front likelihood in the current frame is low, the main subject decision unit 202 does not decide a main subject region.

If a decided main subject region exists (there is the main subject), the main subject decision unit 202 determines whether or not to switch the main subject region based on the front likelihood acquired in step S702 and the reliability determined in step S703. Specifically, the main subject decision unit 202 determines to switch the main subject region if both of the following conditions A and B are satisfied, and determines not to switch the main subject if one or more of the conditions is not satisfied.
Condition A: subject region with highest estimated front likelihood is different from previous frame
Condition B: reliability of front likelihood is high for subject region with highest front likelihood estimated in current frame

In the case of determining to switch the main subject region, the main subject decision unit 202 decides the subject region having the highest front likelihood estimated for the current frame as the new main subject region. On the other hand, in the case of determining not to switch the main subject region, the main subject decision unit 202 maintains the main subject region that has been decided.

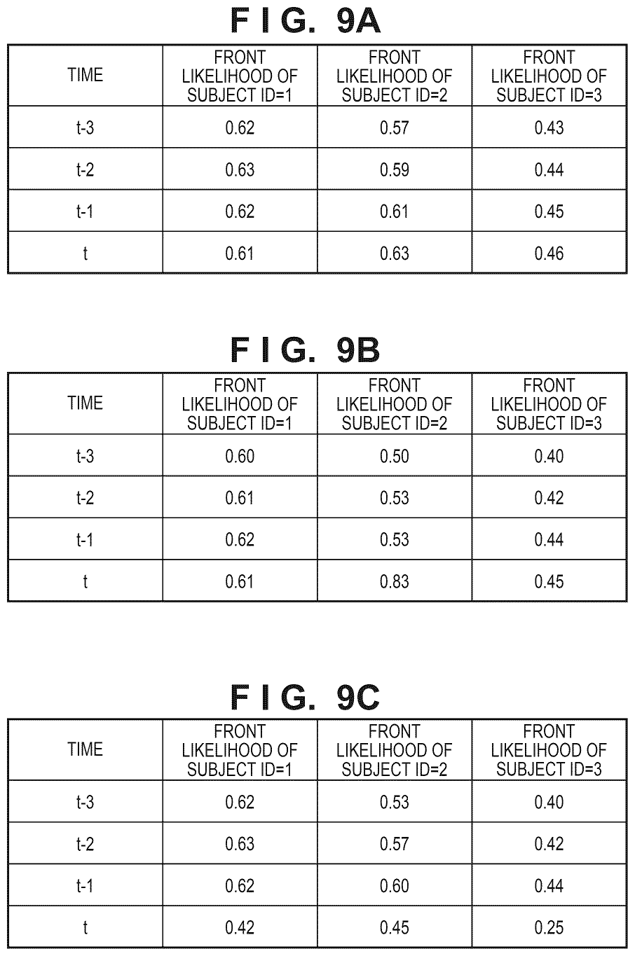

The main subject region switching operation in step S704 will be described in more detail below with reference to FIGS. 9A to 9C. FIG. 9A shows an example of the history of the front likelihood for each subject region at a time t (current frame) and in the three previous frames. The front likelihood history is stored by the main subject decision unit 202 in the RAM 111, for example, and is successively updated after execution of step S702. Hereinafter, the subject regions with the subject IDs 1 to 3 will be referred to as subject regions 1 to 3, respectively. Also, the threshold value θ is set to 0.1.

In this example, there is no change in the magnitude ranking of the front likelihoods of the subject regions up to the previous frame (time t−1), but the subject region with the highest front likelihood changes from the subject region 1 to the subject region 2 in the current frame (time t), and therefore the condition A is satisfied.

Next, the following holds when attention is placed on the subject region 2 with the highest front likelihood and the other subject regions 1 and 3.

$${d}_{2 , 1} ( t ) = {h}_{2} ( t ) - {h}_{1} ( t ) = 0 \text{.63} - 0.61 = 0.02$$

$${d}_{2 , 1} ( t - 1 ) = {h}_{2} ( t - 1 ) - {h}_{1} ( t - 1 ) = 0 \text{.61} - 0.62 = - 0.01$$

$$\vert {d}_{2 , 1} ( t ) - {d}_{2 , 1} ( t - 1 ) \vert = \vert 0.02 - ( - 0.01 ) \vert = 0. 03 < θ$$

$${d}_{2 , 3} ( t ) = {h}_{2} ( t ) - {h}_{3} ( t ) = 0 \text{.63} - 0.46 = 0.17$$

$${d}_{2 , 3} ( t - 1 ) = {h}_{2} ( t - 1 ) - {h}_{3} ( t - 1 ) = 0 \text{.61} - 0.45 = 0.16$$

$$\vert {d}_{2 , 3} ( t ) - {d}_{2 , 3} ( t - 1 ) \vert = \vert 0.17 - 0.16 \vert = 0. 01 < θ$$

Therefore, in step S703, the main subject decision unit 202 determines that the reliability of the front likelihoods estimated for the current frame is high, and the condition B is satisfied. Therefore, in step S704, the main subject decision unit 202 switches the main subject region from the subject region 1 to the subject region 2.

FIG. 9B shows another example of the front likelihood history. In this example, there is no change in the magnitude ranking of the front likelihoods of the subject regions up to the previous frame (time t−1), but the subject region with the highest front likelihood changes from the subject region 1 to the subject region 2 in the current frame (time t), and therefore the condition A is satisfied.

Next, the following holds when attention is placed on the subject region 2 with the highest front likelihood and the other subject regions 1 and 3.

$${d}_{2 , 1} ( t ) = {h}_{2} ( t ) - {h}_{1} ( t ) = 0 \text{.83} - 0.61 = 0 \text{.22}$$

$${d}_{2 , 1} ( t - 1 ) = {h}_{2} ( t - 1 ) - {h}_{1} ( t - 1 ) = 0 \text{.53} - 0.62 = - 0.09$$

$$\vert {d}_{2 , 1} ( t ) - {d}_{2 , 1} ( t - 1 ) \vert = \vert 0.22 - ( - 0.09 ) \vert = 0. 31 > θ$$

$${d}_{2 , 3} ( t ) = {h}_{2} ( t ) - {h}_{3} ( t ) = 0 \text{.83} - 0.45 = 0 \text{.38}$$

$${d}_{2 , 3} ( t - 1 ) = {h}_{2} ( t - 1 ) - {h}_{3} ( t - 1 ) = 0 \text{.53} - 0.44 = 0 \text{.09}$$

$$\vert {d}_{2 , 3} ( t ) - {d}_{2 , 3} ( t - 1 ) \vert = \vert 0.38 - 0.09 \vert = 0. 29 > θ$$

Therefore, in step S703, the main subject decision unit 202 determines that the reliability of the front likelihoods estimated for the current frame is low, and the condition B is not satisfied. Therefore, in step S704, the main subject decision unit 202 does not switch the main subject region, and maintains the subject region 1 having the highest front likelihood in the previous frame as the main subject region.

FIG. 9C shows yet another example of the front likelihood history. In this example, there is no change in the magnitude ranking of the front likelihoods of the subject regions up to the previous frame (time t−1), but the subject region with the highest front likelihood changes from the subject region 1 to the subject region 2 in the current frame (time t), and therefore the condition A is satisfied.

Next, the following holds when attention is placed on the subject region 2 with the highest front likelihood and the other subject regions 1 and 3.

$${d}_{2 , 1} ( t ) = {h}_{2} ( t ) - {h}_{1} ( t ) = 0.45 - 0.42 = 0 \text{.03}$$

$${d}_{2 , 1} ( t - 1 ) = {h}_{2} ( t - 1 ) - {h}_{1} ( t - 1 ) = 0 \text{.60} - 0.62 = - 0.02$$

$$\vert {d}_{2 , 1} ( t ) - {d}_{2 , 1} ( t - 1 ) \vert = \vert 0.03 - ( - 0.02 ) \vert = 0. 05 < θ$$

$${d}_{2 , 3} ( t ) = {h}_{2} ( t ) - {h}_{3} ( t ) = 0.45 - 0.25 = 0 \text{.20}$$

$${d}_{2 , 3} ( t - 1 ) = {h}_{2} ( t - 1 ) - {h}_{3} ( t - 1 ) = 0 \text{.60} - 0.44 = 0 \text{.16}$$

$$\vert {d}_{2 , 3} ( t ) - {d}_{2 , 3} ( t - 1 ) \vert = \vert 0.2 - 0.16 \vert = 0. 05 < θ$$

Therefore, in step S703, the main subject decision unit 202 determines that the reliability of the front likelihoods estimated for the current frame is high, and the condition B is satisfied. Therefore, in step S704, the main subject decision unit 202 switches the main subject region from the subject region 1 to the subject region 2.

Note that in the present embodiment, the reliability is calculated for all of the other subject regions in step S703. However, the number of other subject regions for which the change in the difference in front likelihood is calculated may be restricted. For example, the change in the difference in front likelihood may be calculated for the subject region with the highest front likelihood and a portion of the other subject regions with higher front likelihoods. Conversely, the change in the difference in front likelihood may be calculated for all combinations of the subject regions. In either case, if there is even one change in the difference in front likelihood that exceeds a threshold value, the main subject decision unit 202 determines that the reliability of the front likelihoods is low.

In the present embodiment, the condition B in step S704 is that the reliability of the front likelihood for the subject region subject having the highest front likelihood in the current frame is high. However, the condition may be changed to, for example, the condition that the reliability of the front likelihood is high not only for the subject region with the highest front likelihood but also for all of N subject regions having higher front likelihoods (total number of subject regions≥N≥2).

In the present embodiment, effects similar to those of the first embodiment can be achieved.

### Third Embodiment

Next, a third embodiment of the present invention will be described. Similarly to the second embodiment, the front likelihood is used in the present embodiment, but the method of determining the reliability of the front likelihoods is different. The present embodiment differs from the first and second embodiments in the main subject region decision processing performed in step S308 in FIG. 3, but the configuration of the image processing apparatus and other operations may be similar to those of the first and second embodiments. Therefore, the following description focuses on the operation of the main subject decision unit 202 in the present embodiment.

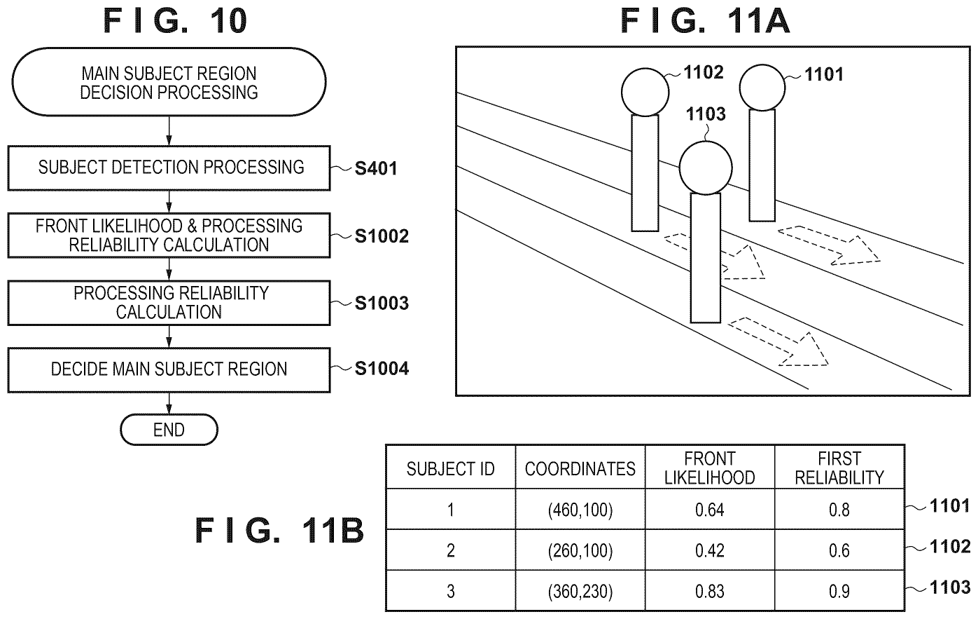

FIG. 10 is a flowchart relating to the main subject determination processing performed by the main subject decision unit 202 in the present embodiment. In FIG. 10, steps for executing the same processing as in the first embodiment are given the same reference numerals as in FIG. 4, and descriptions thereof will be omitted.

In step S1002, the main subject decision unit 202 acquires a front likelihood and the reliability thereof for each of the subject regions detected in step S401. The front likelihood is the same as that described in the second embodiment.

Furthermore, the trained machine-learning model used to estimate the front likelihood in the present embodiment has been configured and trained to output a reliability of inference together with the front likelihood. The reliability is a parameter obtained from the output of, for example, an intermediate layer in the CNN, and will be referred to as the first reliability hereinafter. Also, let h; (t) be the front likelihood estimated for the subject region i detected in the frame at the time t, and let λᵢ(t) be the first reliability of hᵢ(t). λᵢ(t) is either 0 (low reliability) or 1 (high reliability).

FIG. 11A shows an example of an image similar to that in FIG. 5A, except that the reference numbers of the human subjects are different. FIG. 11B shows an example of subject detection results in step S401 for the image shown in FIG. 11A, and the front likelihood and first reliability for each subject region acquired in step S1002. Here too, the human head is detected as the subject region, and image coordinates corresponding to the center of gravity of the subject region are shown as the coordinates of the subject region. Also, the subject IDs 1 to 3 that identify subject regions correspond to the human subjects 1101 to 1103, respectively.

In step S1003, the main subject decision unit 202 determines an overall reliability (called a second reliability) for the front likelihoods acquired in step S1002. The main subject decision unit 202 determines the second reliability based on the first reliability λᵢ(t) acquired in step S1002 for the current frame and the front likelihood hᵢ(t) acquired in the past.

Specifically, the main subject decision unit 202 calculates the second reliability ω2ᵢ(t) of the front likelihood for the subject region i at the time t using the following definitions.

$${ω}_{i}^{′} ( t ) = 1 , if {\sum }_{j} \vert {d}_{i , j} ( t ) - {d}_{i , j} ( t - 1 ) \vert \leq θ$$

$${ω}_{i}^{′} ( t ) = 0 , if {\sum }_{j} \vert {d}_{i , j} ( t ) - {d}_{i , j} ( t - 1 ) \vert > θ$$

$$ω {2}_{i} ( t ) = {λ}_{i} ( t ) \times {ω}_{i}^{′} ( t )$$

Here, d_{i,j}(t) is the difference in front likelihood between the subject region i and the subject region j at the time t, that is to say, d_{i,j}(t)=hᵢ(t)−hⱼ(t). Also, ω′ᵢ(t) is the reliability of the subject region i based on the sum of absolute values of the change in the difference in front likelihood from other subject regions between the previous frame and the current frame.

The second reliability ω2ᵢ(t) is low (=0) when either the reliability output by the trained machine-learning model or the reliability based on the change in the difference between the front likelihoods is low (reliability=0).

In step S1004, the main subject decision unit 202 decides the main subject region from among the subject regions detected in step S401.

In the case where a decided main subject region does not exist (there is no main subject), if the second reliability determined in step S1003 for the subject region with the highest front likelihood in the current frame is high, the main subject decision unit 202 decides the subject region with the highest front likelihood as the main subject region. On the other hand, if the second reliability determined in step S1003 for the subject region with the highest front likelihood in the current frame is low, the main subject decision unit 202 does not decide a main subject region.

If a decided main subject region exists (there is the main subject), the main subject decision unit 202 determines whether or not to switch the main subject region based on the front likelihood obtained in step S1002 and the second reliability determined in step S1003. Specifically, the main subject decision unit 202 determines to switch the main subject region if both of the following conditions A and B are satisfied, and determines not to switch the main subject if one or more of the conditions is not satisfied.
Condition A: subject region with highest estimated front likelihood is different from previous frame
Condition B: second reliability of front likelihoods is high for subject region with highest front likelihood estimated in current frame

In the case of determining to switch the main subject region, the main subject decision unit 202 decides the subject region having the highest front likelihood estimated for the current frame as the new main subject region. On the other hand, in the case of determining not to switch the main subject region, the main subject decision unit 202 maintains the main subject region that has been decided.

According to the present embodiment, when determining whether or not to switch the subject region, consideration is given to both the reliability obtained together with the front likelihood and the reliability based on the amount of change in the front likelihood difference. Therefore, the subject region can be switched more accurately than in the second embodiment.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-007544, filed Jan. 22, 2024, which is hereby incorporated by reference herein in its entirety.

What is claimed is:

1. An image processing apparatus, comprising:
one or more processors that execute a program stored in a memory and thereby function as:
an acquisition unit configured to acquire, from an input image based on image data capturing a scene in which a plurality of subjects are moving in a substantially same direction, information regarding a positional relationship of the plurality of subjects in the direction, with use of a trained machine-learning model; and
a determination unit configured to decide a main subject region from among subject regions respectively corresponding to the plurality of subjects in the image data, based on the information acquired by the acquisition unit,
wherein the determination unit determines whether or not to decide the main subject region, based on a reliability of the information, and decides the main subject region if it is determined to decide the main subject.

2. The image processing apparatus according to claim 1,
wherein the information is a positional order of the plurality of subjects in the direction, and
the determination unit decides, as the main subject region, a subject region corresponding to a subject at a specific positional order among the plurality of subjects.

3. The image processing apparatus according to claim 2,
wherein, in a case where the plurality of subjects include a subject for which a change in the positional order exceeds a predetermined threshold value, the determination unit determines that the reliability of the information is low, and does not decide the main subject region.

4. The image processing apparatus according to claim 3,
wherein the image data is one frame of a moving image, and
in a case where the plurality of subjects include a subject for which a change in the positional order between a current frame and a previous frame exceeds the threshold value, the determination unit determines that the reliability of the information is low, and does not decide the main subject region.

5. The image processing apparatus according to claim 2,
wherein in a case where the plurality of subjects do not include a subject for which a change in the positional order exceeds a predetermined threshold value, the determination unit determines that the reliability of the information is high, and decide, as the main subject region, the subject region corresponding to the subject at the specific positional order.

6. The image processing apparatus according to claim 2,
wherein the specific positional order is first.

7. The image processing apparatus according to claim 1,
wherein the information is a likelihood of a subject being located at a front in the direction, and
the determination unit decides, as the main subject region, a subject region corresponding to a subject of which the likelihood is highest among the plurality of subjects.

8. The image processing apparatus according to claim 7,
wherein in a case where the plurality of subjects include a subject for which a change in a difference in the likelihood from another subject exceeds a predetermined threshold value, the determination unit determines that the reliability of the information is low, and does not decide the main subject region.

9. The image processing apparatus according to claim 8,
wherein the image data is one frame of a moving image, and
in a case where the plurality of subjects include a subject for which a change in the difference in the likelihood between a current frame and a previous frame exceeds the threshold value, the determination unit determines that the reliability of the information is low, and does not decide the main subject region.

10. The image processing apparatus according to claim 9,
wherein in a case where the change in the difference in the likelihood from another subject exceeds the predetermined threshold value for a subject having a highest likelihood in the current frame among the plurality of subjects, the determination unit determines that the reliability of the information is low, and does not decide the main subject region.

11. The image processing apparatus according to claim 8,
wherein the threshold value is a value depending on a total number of the plurality of subjects.

12. The image processing apparatus according to claim 7,
wherein the acquisition unit further acquires, in addition to the likelihood,
a first reliability indicating a reliability of the likelihood, and
the determination unit determines whether or not to decide the main subject region, based on the first reliability and a second reliability that is based on a change in a difference in the likelihood between subjects among the plurality of subjects.

13. The image processing apparatus according to claim 12,
wherein in a case where at least either one of the first reliability and the second reliability is determined to be low, the determination unit does not decide the main subject region.

14. The image processing apparatus according to claim 7,
wherein a magnitude of the difference in the likelihood between two subjects represents a magnitude of a distance between the two subjects in real space.

15. An image capture apparatus comprising:
the image processing apparatus according to claim 1; and
autofocus detecting means for performing automatic focus detection that causes the main subject region decided by the image processing apparatus to be focused.

16. An image processing method comprising:
acquiring, from an input image based on image data capturing a scene in which a plurality of subjects are moving in a substantially same direction, information regarding a positional relationship of the plurality of subjects in the direction, with use of a trained machine-learning model; and
deciding a main subject region from among subject regions respectively corresponding to the plurality of subjects in the image data, based on the information acquired in the acquiring,
wherein the deciding includes determining whether or not to decide the main subject region, based on a reliability of the information and deciding the main subject region if it is determined to decide the main subject.

17. A non-transitory computer-readable medium stores a program which causes, when executed by one or more processors of a computer, the computer to perform an image processing method comprising:
acquiring, from an input image based on image data capturing a scene in which a plurality of subjects are moving in a substantially same direction, information regarding a positional relationship of the plurality of subjects in the direction, with use of a trained machine-learning model; and
deciding a main subject region from among subject regions respectively corresponding to the plurality of subjects in the image data, based on the information acquired in the acquiring,
wherein the deciding includes determining whether or not to decide the main subject region, based on a reliability of the information and deciding the main subject region if it is determined to decide the main subject.
